(19) United States
(12) Patent Application Publication
(10) Pub. No.: US 2002/0188474 A1
(43) Pub. Date: Dec. 12, 2002

(54) System for enabling the reconsideration of a medical study based on the arrival of new information

(76) Inventors: Brian Collamore, Rutland, MA (US); Uan S. Kang, Wesford, MA (US); Joseph M. Luszcz, Hudson, NH (US)

Correspondence Address: PHILIPS ELECTRONICS NORTH AMERICAN, 580 WHITE PLAINS ROAD, TARRYTOWN, NY, 10591, US

(21) Appl. No.: 09/876,690

(22) Filed: Jun. 7, 2001

(51) Int. Cl. G06F 17/60

(52) U.S. Cl. 705/3

(57) ABSTRACT

A system for associating information with a medical study and informing the user of a medical information management system that new information pertaining to the medical study has arrived and should be considered. If the medical study to which the information is associated is not open and under review by the user of the system, the system will append an identifier to the study file, thus informing the user that new information has arrived and has been associated with the study If the medical study to which the information is associated is open and being reviewed by the user of the system, the system will present to the user a graphical user interface (GUI) informing the user that new information pertaining to the currently open study has been received The GUI can also be used to allow the user to acknowledge receipt of the information.

### TECHNICAL FIELD

The present invention relates generally to imaging systems, and, more particularly, to a system for enabling the reconsideration of a medical study in a medical information management system based on the arrival of new information.

### BACKGROUND OF THE INVENTION

Imaging systems, and ultrasonic imaging systems in particular, have been available for quite some time and are commonly used in nondestructive, and sometimes destructive, testing and medical applications. Medical ultrasound imaging typically allows the internal structure of the human body to be viewed non-invasively in real time. The ultrasound imaging system may be capable of various types of imaging applications, including, for example, one and two-dimensional imaging. Furthermore, three and four-dimensional imaging systems are also contemplated for the future.

Typically, one imaging device may be used by a variety of different users, and the images produced by the imaging device may be analyzed and interpreted by a number of different technicians and physicians. In some instances, a number of imaging devices may be interconnected via a network. For example, a number of imaging devices may be located throughout a single facility, such as a hospital or doctor's office. These imaging devices may be interconnected via a network, such as a local area network (LAN). Alternatively, two or more imaging devices located at different locations may be connected via a wide area network (WAN), such as the Internet.

In some applications a computer may be connected to the imaging device or to the network to which the imaging devices are connected. When connected to the imaging device (either directly or via some network), the computer may exchange diagnostic information with the imaging device. For example, the imaging device may transfer the diagnostic image files to the computer. In such an arrangement, the computer may be considered a “server” because it may contain and store image files from any number of imaging devices and make those files available to a user of the server. The server may also include additional software that enables the server to manipulate the image files. A user may wish to access the image files located on the server so that a diagnosis may be made. The user may access the image files on the server either directly from the server, or may access the computer from another computer, commonly referred to as a “client,” connected to the server either directly or via one of the above-described networks. When the server is accessed directly by a user, the server can be thought of as including the client application. In such an arrangement, the server is also considered the client.

Typically, one or more diagnostic images and any patient demographic data relating to the particular patient are combined in the server into what is referred to as a study A user of the system, who wishes to review the image files, can access the study through the client application. Typically, the individual using the system is an imaging technician, referred to as a technologist or a physician. The user can access the study including the related image files and, after having analyzed the images, use the application software on the client to build a report, which will be sent to the physician who requested the diagnostic image, referred to as the “referring physician.” Peripheral data, such as measurements and diagnostic findings, may be added to the report. In some instances, a technologist may develop a preliminary report, which can be saved and later reviewed by an attending physician.

Such a medical information management system may use a communication standard known as Digital Imaging and Communication in Medicine (DICOM) to transfer diagnostic images and store associated studies. According to DICOM, when a medical examination is to be performed, a “Requested Procedure” is generated, where collected information will be collated. According to DICOM, the term “study” corresponds to a collection of information associated with the Requested Procedure, i.e., the collection of information associated with the examination being performed.

Preferably, when a study is complete, it is reviewed by a technologist, or a reviewing physician, who then generates a report based on the information contained in the study. Unfortunately, with currently available communication protocols, such as the DICOM standard and other proprietary protocols, there is no convenient way to indicate whether a study is complete. Instead, current standards support what is referred to as a “send-as-you-go” mode of operation, which allows new information, such as newly acquired ultrasound diagnostic images, to be transferred from an image acquisition device to the server at any time. This additional information is associated with the proper corresponding study by the medical information management system. This situation is not a problem if the study has not yet been reviewed and not yet had a report generated. However, if the study has been reviewed and a report, or a preliminary report, has been generated, and new information arrives, it is difficult to indicate to the individual that has reviewed the information that this new information has arrived. This predicament can jeopardize the diagnosis, as there is no way to be certain that all relevant information has been considered prior to generating the final report.

Furthermore, there may be situations in which all diagnostic images may not be immediately transferred from the image acquisition device to the server. Some examples of this situation include: 1) an inadvertent premature termination of the examination due to user error; 2) deliberate premature termination of the examination, perhaps to accommodate the patient's or another patient's needs; 3) a request for additional artifacts, including, but not limited to, images and/or measurements based on a preliminary review of a study including the information obtained during the examination; or 4) failing of transmission medium, or slow transmission, thereby fragmenting information relating to a single examination. Furthermore, some acquisition devices support a mode of operation in which diagnostic information is collected until the operator chooses to transmit the information collected thus far. Then, the procedure is continued until either another block of information is collected and sent, or until the procedure is terminated and all remaining information for the procedure is transferred.

In order to communicate that a study is complete and ready for review, some systems assume that the closure of the network connection between the image acquisition device and the server indicates that the study is complete. Other systems make the assumption that a study is complete and ready for review when new information has not arrived at the server for a predetermined amount of time. Furthermore, there are other DICOM services, such as the Modality Performed Procedure Step and Storage Commitment that may be used by the server to determine that an individual procedure is complete. Unfortunately, the Modality Performed Procedure Step cannot indicate whether a study is complete. Furthermore, this DICOM service is optional. Regardless, once the server determines that a study is complete and ready for review, there is no way to be certain that late arriving information will be considered prior to generating the report for the aforementioned reasons. Indeed, new information may even be added to a study while the study is being reviewed, or after the study is finalized and a report generated. Unfortunately, this new information may contain clinically relevant data, and, if not considered, may jeopardize the accuracy of the diagnosis.

Therefore, it would be desirable to have a medical information management system that can reconsider a medical study based on the arrival of new information.

### SUMMARY

The invention is a system for associating information with a medical study and informing the user of a medical information management system that new information pertaining to the medical study has arrived and should be considered. If the medical study to which the information is associated is not open, but has been previously reviewed by a user of the system, the system will append an identifier to the study file, thus informing the user that new information has arrived and has been associated with the study. If the medical study to which the information is associated is open and being reviewed by a user of the system, the system will present to the user a graphical user interface (GUI) informing the user that new information pertaining to the currently open study has been received. The GUI can also be used to allow the user to acknowledge receipt of the new information.

Other systems, methods, features, and advantages of the invention will be or will become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The present invention can be better understood with reference to the following drawings. The components within the drawings are not necessarily to scale relative to each other, emphasis instead being placed upon clearly illustrating the principles of the present invention.

FIG. 1 is a graphical view illustrating an exemplar network environment in which the server including the medical information management system resides.

FIG. 2 is a schematic view illustrating the server of FIG. 1 in which the medical information management system resides.

FIG. 3 is a block diagram illustrating exemplar portions of the records maintained in the database of FIG. 2.

FIG. 4 is a flow diagram illustrating the operation of one embodiment of the medical information management system of FIG. 2.

FIG. 5 is a flow diagram illustrating the operation of an aspect of the client application of the medical information management system of FIG. 2.

FIG. 6 is a graphical view illustrating an exemplar user interface of the medical information management system of FIG. 2.

### DETAILED DESCRIPTION OF THE INVENTION

The medical information management system of the invention can be implemented in hardware, software, firmware, or a combination thereof. In the preferred embodiment(s), the medical information management system is implemented using a combination of hardware and software or firmware that is stored in a memory and that is executed by a suitable instruction execution system. If implemented in hardware, as in an alternative embodiment, the medical information management system can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Furthermore, while described in the context of ultrasound imaging information, the invention is applicable to any type of information that will become part of a medical study. Such information is typically referred to as an “artifact” and is applicable to any medical information system. Artifacts may include, as non-limiting examples, waveforms, chart records, audio recordings for operator comments, Doppler flow sounds or heart sounds, measurements, calculations, findings (free-text or coded), and reports. Further, the invention is applicable to other types of medical studies, for example, but not limited to, electro-cardiogram (ECG) management systems. Further still, the term “study” as used herein refers to the “collected,” instead of the “collection, or collecting, of' information.

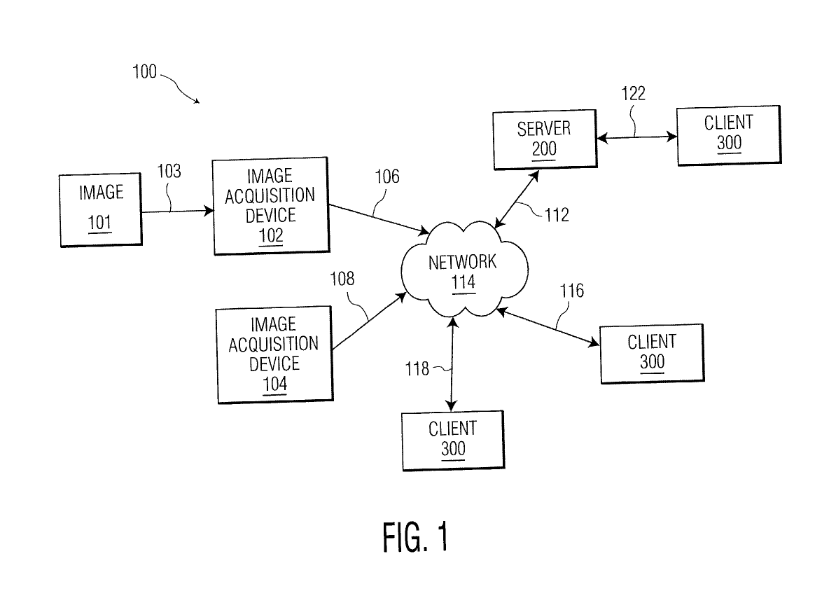

FIG. 1 is a graphical view illustrating an exemplar network environment 100 in which the server including the medical information management system resides. It should be noted that although illustrated in FIG. 1 as connected through a network, the medical information management system of the invention is not dependent upon the network connectivity described.

The network environment 100 includes at least one acquisition device 102, which for this example is an image acquisition device, connected to a network 114 via connection 106. The network environment 100 also includes an image acquisition device 104 connected to network 114 via connection 108. The image acquisition devices 102 and 104 can be any electronic devices capable of developing an electronic image 101, and in this embodiment, are ultrasonic diagnostic devices. However, other devices for developing other information pertinent to a medical study may be used. The network 114 can be any local area network (LAN) or wide area network (WAN).

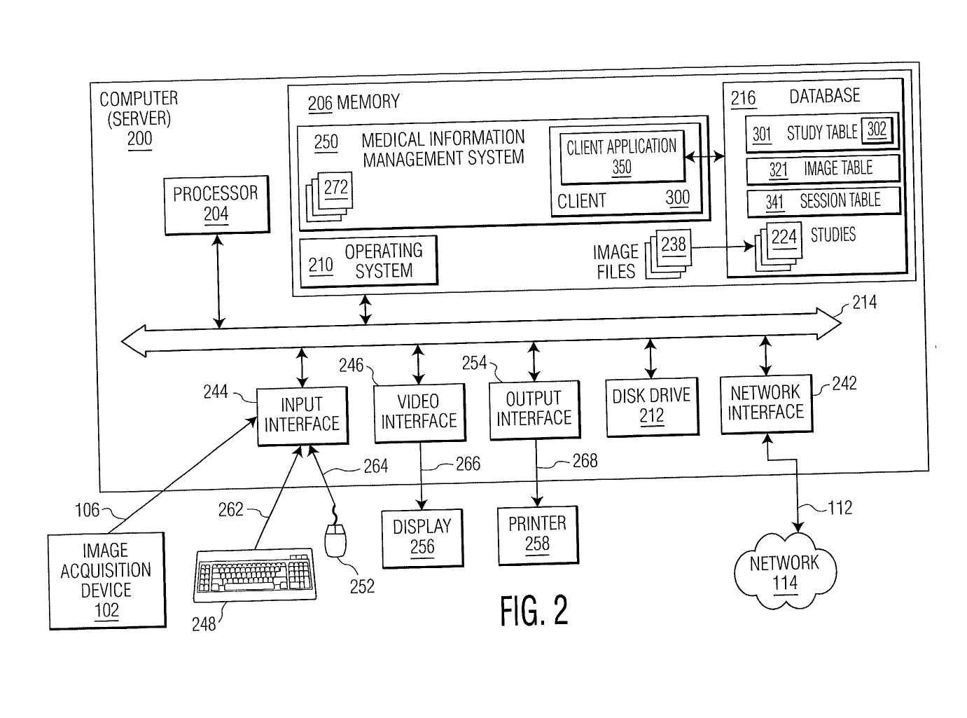

The network environment 100 also includes a server 200 connected to the network 114 via connection 112, and a client 300 connected to the server 200 via connection 122. Alternatively, the client 300 may be included within the server 200 or may be connected to the network 114 via, for example, connections 116 and 118. Furthermore, more than one client 300 may be coupled to the server 200, either directly or via the network 114. As will be described in further detail with respect to FIGS. 2 through 6, the server 200 includes a medical information management system that works in cooperation with a client application, which is part of the client 300, to notify an individual that new information is available for a particular study. The new information may be additional images 101 generated by the image acquisition device 102, measurement information, findings, or any other information that may be relevant to the analysis of a medical study and the generation of the report. If the client 300 is contained within the server 200, then the client application will also be contained within the server 200. Furthermore, it is possible for the server 200 and the client 300 to be incorporated into the image acquisition device 102, in which case all of the functionality for the server 200, client 300 and the image acquisition device 102 as described herein is included in a single device.

Preferably, information can be exchanged over the network 114 using, for example, the DICOM communication standard mentioned above. Alternatively, other proprietary communication protocols may be used to transfer information over the network 114.

In the currently contemplated best mode, the medical information management system is implemented in software and executed by a special or general purpose computer, such as a personal computer (PC; IBM-compatible, Apple-compatible, or otherwise), workstation, minicomputer, or mainframe computer. An example of a general purpose computer that can implement the image management system of the invention is shown in FIG. 2.

FIG. 2 is a block diagram illustrating a computer 200 that includes the medical information management system 250 of the invention. The computer 200 can be a general purpose computer that can implement the medical information management system 250, and will be referred to as a server. Generally, in terms of hardware architecture, as shown in FIG. 2, the computer 202 includes a processor 204, a memory 206, a disk drive 212, an input interface 244, a video interface 246, an output interface 254, and a network interface 242 that are connected together and can communicate with each other via a local interface 214. The local interface 214 can be, for example but not limited to, one or more buses or other wired or wireless connections, as is known in the art. The local interface 214 may have additional elements, which are omitted for simplicity, such as buffers (caches), drivers, and controllers, to enable communications. Further, the local interface 214 includes address, control, and data connections to enable appropriate communications among the aforementioned components. The disk drive 212 may include, for example, multiple disk drives arranged in multiple storage configurations, and may include, for example, magnetic, optical, or other storage formats.

The processor 204 is a hardware device for executing software that can be stored in memory 206. The processor 204 can be any custom made or commercially available processor, a central processing unit (CPU) or an auxiliary processor among several processors associated with the computer 200, and a microchip based microprocessor or a macroprocessor. Examples of suitable commercially available microprocessors are as follows: an 80×86 or Pentium series microprocessor from Intel Corporation, a PowerPC microprocessor from IBM, a Sparc microprocessor from Sun Microsystems, Inc., a PA-RISC series microprocessor from Hewlett-Packard Company, or a 68××× series microprocessor from Motorola Corporation.

The memory 206 can include any one or a combination of volatile memory elements (e.g., random access memory (RAM, such as DRAM, SRAM, etc.)) and nonvolatile memory elements (e.g., ROM, hard drive, tape, CDROM, etc.). Moreover, the memory 206 may incorporate electronic, magnetic, optical, and/or other types of storage media. Note that the memory 206 can have a distributed architecture, where various components are situated remote from one another, but can be accessed by the processor 204.

The input interface 244 can receive commands from, for example, keyboard 248 via connection 262 and from mouse 252 via connection 264 and transfer those commands over the local interface 214 to the processor 204 and the memory 206. The input interface 244 may also receive, for example, diagnostic images, in the form of image files, from image acquisition device 102 via connection 106. The image files may be electronically stored in memory 206 as image files 238.

The video interface 246 supplies a video output signal via connection 266 to the display 256. The display 256 can be a conventional CRT based display device, or can be any other display device, such as a liquid crystal display (LCD) or other type of display.

The output interface 254 sends printer commands via connection 268 to the printer 258. The network interface 242 can be, for example, a network interface card that connects the computer 200 via connection 112 to a network 114, which in this case would be a LAN. Alternatively, the network interface 242 could be a modulator/demodulator (modem) or any communication device capable of connecting the computer 200 to a network 114, which in this example would be a WAN, such as the Internet. The network interface 242 may also be used to receive electronic files from another acquisition device connected to the network 114.

The software in memory 206 may include one or more separate programs, each of which comprises an ordered listing of executable instructions for implementing logical functions. In the example of FIG. 2, the software in the memory 206 includes the medical information management system 250, a client 300 having a client application 350, and a suitable operating system (O/S) 210. A nonexhaustive list of examples of suitable commercially available operating systems 210 is as follows: a Windows operating system from Microsoft Corporation, a Netware operating system available from Novell, Inc., a UNIX operating system, which is available for purchase from many vendors, such as Sun Microsystems, Inc., Hewlett-Packard Company, and AT&T Corporation, or the readily available LINUX operating system. The operating system 210 essentially controls the execution of other computer programs, such as the medical information management system 250 and the client application 350, and provides scheduling, input-output control, file and data management, memory management, and communication control and related services. The operating system 210, the medical information management system 250 and the client application 350 can be implemented using any of the aforementioned operating systems

The client application 350 is used to access a study saved on the server 200 and review the contents of the study to form a report. The report includes a diagnosis of the information contained in the study. In accordance with an aspect of the invention, the medical information management system 250, along with the client application 350 and a database 216 contained in memory 206, is used to alert an individual that is analyzing a study that new information relating to the study has arrived and should be considered The medical information management system 250 can alert an individual to the arrival of new information if the new information arrived when the study was closed, or previously saved, and can alert the individual to the arrival of new information even when the individual is actively reviewing the study to which the new information relates. This is accomplished through the use of a graphical user interface that alerts the user to the arrival of new information. In operation, the client application 350 periodically polls the database to determine whether a flag is set, thus indicating the presence of new information related to the study. The flag is an indicator field maintained in the database 216 and associated with the study. To set the flag, the acquisition device 102 communicates with the server 200. In one embodiment, a windows NT Service running on the server 200 receives a signal from the acquisition device 102 and executes a structure query language (SQL) command that causes the flag to be set in the database 216 However, other methodologies for setting flags in databases are possible.

If the flag is set, thus indicating the arrival of new information relating to the study, the client application 350 causes the graphical user interface to be presented to the user, thus alerting the user to the arrival of new information.

The processor 204 and operating system 210 define a computer platform, for which application programs, such as the medical information management system 250 and the client application 350, are written in higher level programming languages The client application 350 also provides the user interface through which a user of the system communicates with the computer 200 and the medical information management system 250. The user interface component of the client application uses, for example, the keyboard 248 and mouse 252 to provide input to the computer 200 and uses the display 256 to provide output.

If the computer 200 is a PC, the software in the memory 206 further includes a basic input output system (BIOS) (omitted for simplicity). The BIOS is a set of essential software routines that test hardware at startup, start the O/S 210, and support the transfer of data among the hardware devices. The BIOS is stored in ROM so that it can be executed when the computer 200 is activated.

When the computer 200 is in operation, the processor 204 is configured to execute software stored within the memory 206, to communicate data to and from the memory 206, and to generally control operations of the computer 200 pursuant to the software. The medical information management system 250, client application 350 and the O/S 210, in whole or in part, but typically the latter, are read by the processor 204, perhaps buffered within the processor 204, and then executed.

The memory 206 includes, for exemplar purposes only, a plurality of image files 238 that are transferred to the computer 200 from, for example, the acquisition device 102 Each image file 238 corresponds to a diagnostic ultrasound image 101 (FIG. 1). When the image files 238 are received by the computer 200, the medical information management system 250 associates each image file 238 with a study 224. The studies 224 are maintained in a database 216 associated with the memory 206. When an image file 238 arrives, the medical information management system 250 determines whether the image file 238 is associated with a previously stored study 224. If it is, then the image file 238 is stored in the corresponding study 224. If the image file 238 is the first piece of information to arrive, then a new study record is created in the database 216 and the image file 238 is associated thereto.

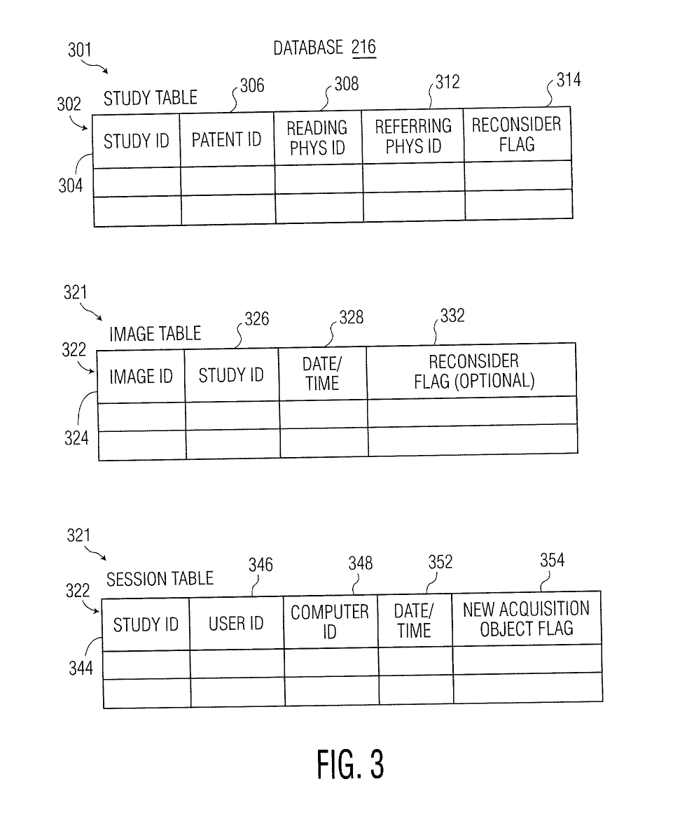

The database 216 can be implemented using, for example, Microsoft SQLServer, and includes, among many other things, a study table 301, a plurality of studies 224 each having an associated study record 302 (to be described in FIG. 3), an image table 321 and a session table 341. Other database implementations, and alternatives to database implementations, such as indexed sequential access method (ISAM) tree implementations and file systems, as known to those having ordinary skill in the art, are possible. The study table 301 includes, among other items, a reading physician identifier field and a referring physician identifier field to be described in detail below. The study table 301 is electronically linked to the client application 350, so that each reading physician identified in the study table can access the studies 224 stored in the database 216. Typically, a system administrator accesses a tool (not shown) that allows the system administrator to correlate and maintain the list of reading physicians maintained in the study table 301. The studies 224 include any corresponding image files 238 and any patient demographic data relating to the particular patient.

Once an image file 238 is made available to the medical information management system 250, the medical information management system 250 and the client application 350 can associate each of the image files 238 with the appropriate study 224. A reading physician can then access the study 224 and associated image files 238 to perform a diagnosis and create a report 272 that is stored in the memory 206. In addition to providing the user interface into the computer 200, the client application 350 may also include additional functionality, such as a measurements package, which allows the user of the system to append measurements to the image file, or a diagnostics package, which allows a user to append diagnostic findings to the image file. Furthermore, the study 224 may include other artifacts besides imaging information. For example, but not limited to, the study 224 may include waveforms, chart records, audio recordings for operator comments, Doppler flow sounds or heart sounds, calculations, (free-text or coded), and reports.

When the medical information management system 250 is implemented in software, as is shown in FIG. 2, it should be noted that the medical information management system 250 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The medical information management system 250 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following, an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the medical information management system 250 is implemented in hardware, the medical information management system 250 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

FIG. 3 is a block diagram illustrating exemplar portions of the records maintained in the database 216 of FIG. 2. The database 216 includes study table 301, which includes one or more study records, an exemplar one of which is illustrated using reference numeral 302. The study record 302 includes a study identification (I.D.) field 304, a patient I.D. field 306, a reading physician I.D. field 308, a referring physician I.D. field 312 and a reconsider flag 314. In accordance with an aspect of the invention, the reconsider flag field 314 is set to indicate to a user the arrival of new information that is to be added to the study record 302.

The database 216 also includes at least one image table 321. The image table includes at least one image record 322, which includes an image I D field 324, a study I.D. field 326, a date/time I.D. field 328, and, optionally, a reconsider flag field 332. The database 216 also includes session table 340, which includes one or more session records, an exemplar one of which is illustrated using reference numeral 342. Each session record 342 includes a study I.D. field 344, a user I.D. field 346, a computer I.D. field 348, a date/time field 352 and a new acquisition object flag 354.

Each time a user opens a study, a record 342 in the session table 340 is created When the reconsider flag 314 is set in the study record 302, the new acquisition object flag 354 is also set for every session record 342 for that study. When the user closes the study, the session record 342 is removed. If a study remains unread, then new information should not affect the status of the reconsider flag 314. However, it is still desirable to notify the users that have open session records. This is accomplished by setting the new acquisition object flag 354 in the session record 342. As will be described below, the user is presented with a graphical user interface (GUI) that informs the user that new information has arrived for the open study. When the user acknowledges that the new images have arrived, the reconsider flag 314 and the new acquisition object flag 354 are cleared by the client application 350 executing an SQL command that causes the flags to be cleared in the database 216. Optionally, the reconsider flag might be set in the image record 322 as reconsider flag 332. Because all flagged images should be considered by the user when creating the report, this image and all subsequent images should be considered. Alternatively, it is possible to populate the reconsider flag field 314 with the image I.D. (field 324 in the image record 322) of the first unreviewed image. All the various ways of setting flags in the database 216 to alert a user that new information has arrived are within the scope of the invention.

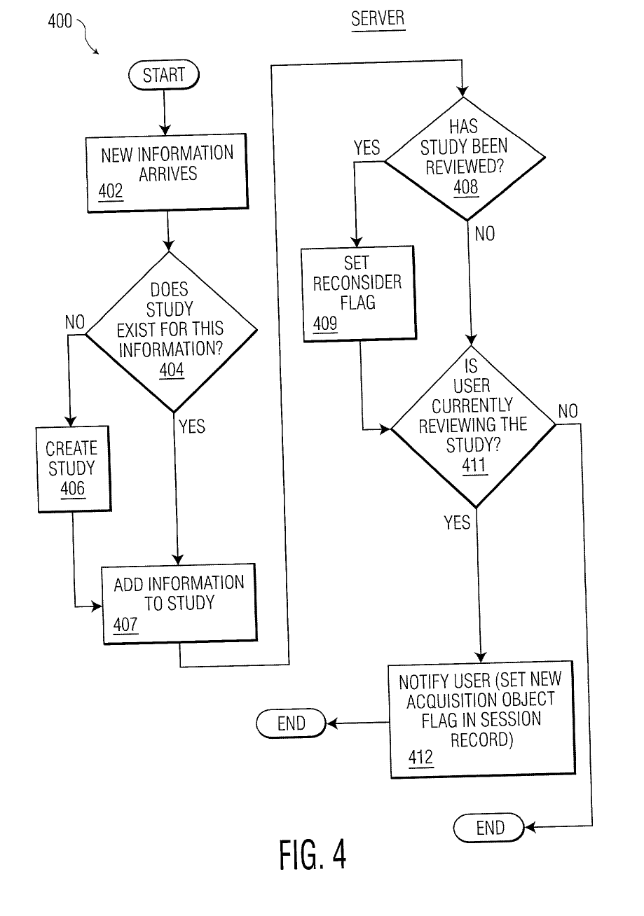

FIG. 4 is a flow diagram 400 illustrating the operation of one embodiment of the medical information management system 250 of FIG. 2 In block 202 new information arrives from the image acquisition device 102 In this example, the new information is an ultrasound diagnostic image 101 (FIG. 1). However, the new information can be any information that is to be made a part of a medical study 224 (FIG. 2). The newly arrived image is transferred to the memory 206 of computer 200 and electronically stored as an image file 238. It should be mentioned that the image can arrive via direct transfer from an image acquisition device 102, via the network 114, via the merging of more than one study, or any other way.

Furthermore, the medical information management system 250 and the client application 350 will work on any newly arrived information. For example, although described herein as a newly arrived image file 238, the arrival of any type of information that should be added to a study and considered by the individual reviewing the study can be added to the study and the user alerted accordingly For example, patient measurements, calculations, findings, comments, waveforms, chart records, audio recordings, Doppler audio, Doppler flow sounds or heart sounds, diagnosis, patient I.D. information, a medical study report, etc., can be added to a study and the user alerted to the arrival of such information.

In block 404, it is determined whether a study exists that corresponds to this newly acquired information. For example, when the image file 238 is transferred to the memory 206, the database 216 will be queried by the medical information management system 250 to determine whether there is a study that has an identification code (study ID field 326 of FIG. 3) corresponding to the identification code (study ID field 344 of FIG. 3) of the newly arrived image file 238. If the newly arrived image file 238 does not have an associated study 224, then in block 406 a study record 302 (FIG. 3) is created in the database 216. If a study already exists corresponding to the newly acquired image, then in block 407 that image is added to the study.

In block 408, it is determined whether the particular study 224 with which the newly acquired image file 238 is associated has yet been reviewed Typically, a reading physician will review the study and create a report 272 that includes a diagnosis of the information contained within the study 224. If, in block 408, it is determined that the study to which the newly arrived information has been added has already been reviewed, then, in block 409, the reconsider flag (314 of FIG. 3) is set to indicate the arrival of this new information. When the client application 350 polls the database 216, the reconsider flag 314 will be detected by the client application 350. In response to the reconsider flag 314, the client application 350 will display an appropriate GUI to the user, thus instructing the reviewing physician that new information has been added to the study. When the reading physician eventually opens the study to again analyze it, they will be presented with an indicator, based on the reconsider flag 314, informing them that the study they are about to analyze includes new information. Communication between the client application 350 and the database 216, as known to those having ordinary skill in the art, can be in accordance with an industry standard technology, such as, for example Open Database Connectivity (ODBC) or Active X Data Objects (ADO).

The invention allows a reading physician, identified using ID field 308 in the study record 302 of FIG. 3 308, or a referring physician identified using ID field 312 in the study record 302 of FIG. 3, who may be taking diagnostic and/or therapeutic action based on the previously received report (i.e., the report that does not include the new information) to have the latest diagnostic information available to aid in proper diagnosis.

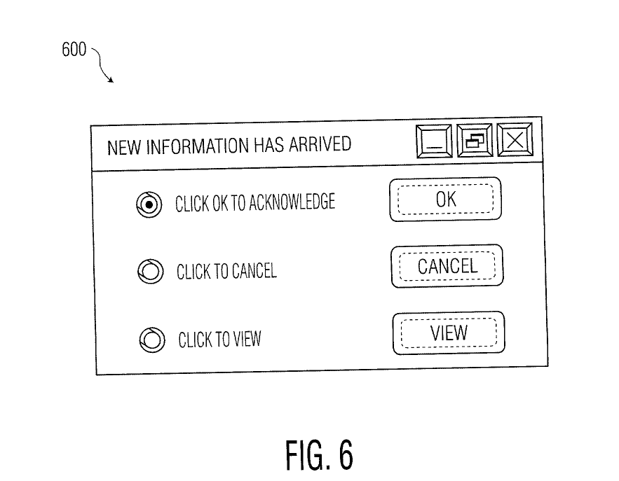

After the reconsider flag 314 is set in block 409, then in block 411 it is determined whether there is a user currently reviewing the study. If it is determined in block 411 that a user is currently reviewing the study, then, in block 412, the new acquisition object flag (354 of FIG. 3) in the session record 342 (FIG. 3) is set. The client application 350 periodically polls the database 216 to determine whether the new acquisition object flag (354 of FIG. 3) is set. In such an instance, the user may be presented with a graphical user interface, such as that shown below in FIG. 6, to inform the user that new information has arrived. The GUI may also require that the user provide acknowledgement that the new information has been received. The GUI may also present the user with the opportunity to immediately view the newly arrived information, or the new information may be presented to the user automatically. If, in block 411 it is determined that no user is currently reviewing the study, then the process ends.

It should be noted that, instead of depending on the client application 350 to poll the records in the database 216 to detect the reconsider flag 314, 332 or the new acquisition object flag 354, other technologies could be used to inform the user that new information has become available. For example, any available inter-process communication, such as Distributed Component Object Model (DCOM) or Simple Object Access Protocol (SOAP) can be used.

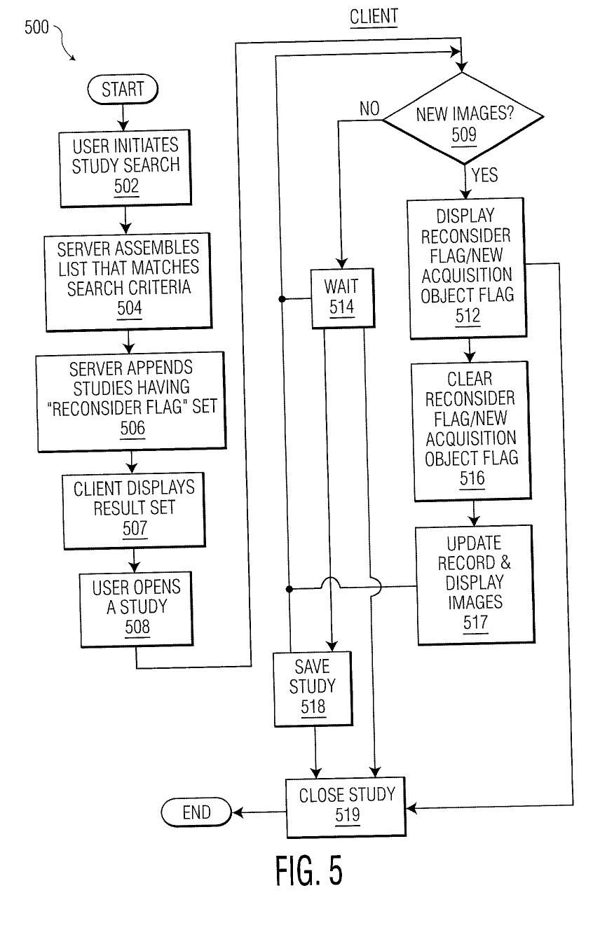

FIG. 5 is a flow diagram 500 illustrating the operation of an aspect of the client application 350 of the medical information management system 250 of FIG. 2. In block 502 a user of the client 350 will initiate a study search in order to produce a list of all studies that are to be analyzed, and have reports generated therefor. It should be mentioned that other types of searches may include reconsideration notification in accordance with the invention In block 504, the server 200 assembles a list that matches the search criteria entered by the user in block 502.

In block 506, the medical information management system 250 will append to the list generated in step 504 any studies that have the reconsider flag (314 of FIG. 3) set. In this manner, when the list of studies is produced and displayed to the user, the user will see a list of studies that include both studies that have not had any information added thereto (which match their search criteria), and will clearly see studies that have had information added thereto (which may or may not have matched their search criteria). Next, in block 507, the client application 350 displays to the user the results of the search. In this manner, any studies that have new information added thereto are clearly displayed to the user of the client application 350

In block 508, a user chooses the study that they wish to review and they open the study. Next, in block 509, it is determined whether there are any new images added to the opened study. If no new images are received during the time that the user has the study open, then the process will wait in block 514. The process will wait in the background of the client application 350 while the user analyzes the study until either the user closes the study in block 519, or until the study is saved in block 518.

If a new image arrives in block 509, then, in block 512, the reconsider flag (314 of FIG. 3) and, if an active session record 342 is in progress, the new acquisition object flag (354 of FIG. 3) will be set to notify the user that a new image has arrived while they are reviewing the study. The reconsider flag 314 is linked to the study record 302, while the new acquisition object flag 354 is linked to each user's session record 342. If there are no sessions in progress, only the reconsider flag 314 can be set because the session record 302 should not exist. The reconsider flag 314 is used to display these special studies in the study search result sets. The new acquisition object flag 354 is set for each active session record 342. As mentioned above, the user may be presented with the dialog box 600 shown in FIG. 6 in which the medical information management system 250 informs the user that new information has arrived. The dialog box 600 may optionally require an acknowledgement from the user

Alternatively, the user may be presented with a “modeless” single button on a control panel or a toolbar of a user interface. This single button may act as a clear signal that new images have arrived. The user may continue working if they choose, disregarding the button. Clicking the button acts as acknowledgement and clears the reconsider flag 314, unless it has been cleared by another user. Clicking the button will also clear the new acquisition object flag 354.

After the user has been made aware of the arrival of new information in block 512, the user can either click to acknowledge (the OK button in FIG. 6) in which case the reconsider flag 314 and the new acquisition object flag 354 will be cleared in block 516. Alternatively, the user can close the study without saving (while the reconsider flag 314 and the new acquisition object flag 354 is still set) in block 519. Closing the study while the reconsider flag 314 or the new acquisition object flag 354 is set and unacknowledged is not preferable, but may be done based on customer preference.

After the user acknowledges the new study information in block 516, then, in block 517, the server updates the reconsider flag 314 and the new acquisition object flag 354 in the study record (302 of FIG. 3), displays the new study information, and the process returns to block 509. After the study is saved in block 518, the user closes the study in block 519. Alternatively, the save operation in block 518 and the close operation in block 519 can be performed as one step, in which the user closes the study in block 519 after the study record (302 of FIG. 3) is updated in block 517.

It may also be desirable to have the ability to add new information to a study 224 after the study 224 and the report 272 with which it is associated is finalized However, it may be desirable to allow the finalized study to have new information added thereto only while the finalized study 224 and report 272 are located on the server 200.

FIG. 6 is a graphical illustration showing one possible embodiment of the user interface used by the medical information management system 250 to alert a user that new information has arrived. The dialog box 600 is presented to a user while they are reviewing a study to inform the user that new information has arrived. The “OK” button can be actuated by the user to indicate to the medical information management system 250 (FIG. 2) that the user is aware of the arrival of the new information. Alternatively, as stated above, a single button may be presented to the user.

It will be apparent to those skilled in the art that many modifications and variations may be made to the preferred embodiments of the present invention, as set forth above, without departing substantially from the principles of the present invention. For example, the present invention can be used in any medical information management system. All such modifications and variations are intended to be included herein within the scope of the present invention, as defined in the claims that follow.

What is claimed is:

1. A medical information management system, comprising:
an information acquisition device;
a computer coupled to the information acquisition device, the computer including logic for receiving information from the information acquisition device, and
a memory element associated with the computer, where the memory element stores the information and associates the information with a study; where new information transferred to the computer is associated with the study, and the study is flagged to indicate that new information is available.

2. The medical information management system of claim 1, wherein the information includes at least one of ultrasound image information, medical image information, patient measurements, calculations, findings, comments, waveforms, chart records, audio recordings, Doppler audio, Doppler flow sounds or heart sounds, Doppler audio, and a medical study report.

3. The medical information management system of claim 2, further comprising a database, where the database includes a plurality of flags, and at least one of the flags is used to indicate to a user of the medical information management system that the new information has been associated with the study.

4. The medical information management system of claim 3, further comprising a client application, the client application further comprising a user interface configured to present to the user of the medical information management system an indication that the new information has been associated with a study.

5. The medical information management system of claim 4, where the client application informs the user of the arrival of new information while the user is reviewing the study to which the new information corresponds.

6. The medical information management system of claim 4, where the client application informs the user of the arrival of new information pertaining to a study that the user is not reviewing.

7. A method for adding new information to a medical study, the method comprising the steps of:
acquiring diagnostic information using an information acquisition device;
forwarding the information to a computer;
storing the information;
associating the information with a medical study;
transferring new information to the computer;
associating the new information with the study; and
indicating, in the study, that new information is available.

8. The method of claim 7, wherein the information includes at least one of ultrasound image information, medical image information, patient measurements, findings, calculations, comments, waveforms, chart records, audio recordings, Doppler audio, Doppler flow sounds or heart sounds, Doppler audio, and a medical study report.

9. The method of claim 8, further comprising the step of using a database indicator to indicate to a user of the medical information management system that the new information has been associated with the study.

10. The method of claim 9, further comprising the step of presenting to the user of the medical information management system an indication that the new information has been associated with a study.

11. The method of claim 10, further comprising the step of informing the user of the arrival of new information while the user is reviewing the study to which the new information corresponds.

12. The method of claim 10, further comprising the step of informing the user of the arrival of new information pertaining to a study that the user is not reviewing.

13. A computer readable medium having a program for adding new information to a medical study, the program comprising logic for performing the steps of:
acquiring diagnostic information using an information acquisition device;
forwarding the information to a computer;
storing the information;
associating the information with a medical study;
transferring new information to the computer;
associating the new information with the study; and
indicating, in the study, that new information is available.

14. The program of claim 13, wherein the information includes at least one of ultrasound image information, medical image information, patient measurements, findings, calculations, comments, waveforms, chart records, audio recordings, Doppler audio, Doppler flow sounds or heart sounds, Doppler audio, and a medical study report.

15. The program of claim 14, further comprising logic for using a database indicator to indicate to a user of the medical information management system that the new information has been associated with the study.

16. The program of claim 15, further comprising logic for presenting to the user of the medical information management system an indication that the new information has been associated with a study.

17. The program of claim 16, further comprising logic for informing the user of the arrival of new information while the user is reviewing the study to which the new information corresponds.

18. The program of claim 16, further comprising logic for informing the user of the arrival of new information pertaining to a study that the user is not reviewing.
